(19) United States
(12) Patent Application Publication
(10) Pub. No.: US 2010/0030610 A1
(43) Pub. Date: Feb. 4, 2010

(54) Method and System for Controlling and Managing an Organization

(76) Inventor: Ram Gomeh, Hod-Hasharon (IL)

Correspondence Address: Ram Gomeh;4 Afek St., P.O. Box 6409, Hod-Hasharon, IL

(21) Appl. No.: 12/203,162

(22) Filed: Sep. 3, 2008

Related U.S. Application Data
(60) Provisional application No. 60/935,866, filed on Sep. 5, 2007.

(51) Int. Cl. G06Q 10/00

(52) U.S. Cl. 705/9; 705/7; 705/8; 707/104.1

(57) ABSTRACT

A system and a method for generating computer displays of data and information for management and real-time control of an organization utilizing critical performance indicators of performance states in all operational activities. The data and information are displayed in networked computer screens using algorithms to efficiently handle all the myriad elements constituting the day-to-day operation of an organization. The CEO can observe on his screen any selected data from all the operating units. The CEO is immediately informed of a bottleneck in operation for his attention. Every senior manager of a department continuously receives the relevant actual performance data of his department, presenting the results of executed activities. This information is displayed in selectable operating periods. Managers are also able to view the displays on screens of other departments and review data giving them information on their performance as much as it relates to their operating unit within an organization.

### FIELD OF THE INVENTION

The present invention generally relates to the field of information management and control systems and more particularly, to a system and a method for simplified real-time control of an ERP (Enterprise Resource Program) system's level of performance within an organization, and more particularly for a system and a method for analyzing and controlling the level of performance of critical key activities within an organization—while simultaneously viewing displays of information about each activity filtered in accordance with predetermined values.

### BACKGROUND OF THE INVENTION

The present invention incorporates by reference the published U.S. Provisional Pat. Application 60/935,866 by the Applicant dated Sep. 5, 2007.

It is well known that as the need for and the use of organizational data and information increases and becomes more complex, the managers of sprawling organizations are searching for ways and means that would enable them to alleviate their task of studying a clear, accurate and up-to-date picture of the organization's current state and operation.

Nowadays, there are known, to those skilled in the art, many computer programs dealing in—and providing managers with graphical and numerical presentations, suggesting a plethora of information aimed at improving the organization's capabilities and the control means available to its management. There exist currently a proliferation of various Enterprise Resource Planning (ERP) systems that are being integrated into computerized systems of organizations, as an infrastructure for collecting the organizational information and analyzing it in order to arrive at optimal organizational decisions. However, these ERP systems that eventually have to handle vast quantities of organizational information, became “clumsy” (rather complicated and ungainly) in the configurations which materialize and which are at the disposal of the management of the enterprise.

Furthermore, ERPs are often too rigid and too difficult to adapt to the specific workflow and business process of some organizations and therefore may cause failure, or, at the very least, decreased revenues and poor return on investment specifically for business organizations.

It has become highly evident that the information proper and its handling procedures must be simplified for the sake of being accessible and serviceable to top managers responsible for decision-making and to the management ensemble as such. This state of affairs led to efforts aimed at developing “business intelligence” (BI) programs which provided venues for analyzing and presenting the organizations' data utilizing visual displays and various types of organizational charts, graphs, tables and the like.

It is evident that the demand for BI programs shows that there is a need for presenting lucid, visually analyzed and understood data to top management and that this is a pressing and important need. However, all the currently available BI programs still mandate that every member of the company management shall dedicate a rather significant part of his time to learn the method, and devote even more time required for switching between various computer screens for each managerial unit within an organization, Generally multiple screens or “windows” must be used since each managerial unit provides its own specific data and information and it requires further investment of time for investigating and analyzing the information before arriving at a conclusion (i.e., a sought for and reasoned decision). These requirements often pose an extra burden on already time-stressed managerial personnel and can limit the effective implementation of currently available BI programs.

Hence, it is still required that one more step forward should be made, a step that will provide, simultaneously—both simplicity and immediate focusing on the relevant data—and that will contain and encompass the essence of all the relevant information provided to the management team, presented in a timely, user-friendly manner that reflects a concise, encompassing view of the organization's performance.

### SUMMARY OF THE INVENTION

Accordingly, it is a principle object of the present invention to overcome the disadvantages and limitations of prior art systems and provide a Management and Control System for Organizations (MCSO), constituted in accordance with the principles of the present invention, which will display organizational data and information, all on a single screen—so that in one quick glance every senior manager and the responsible organization head are able to discern in real-time what is going on in the organization and quickly arrive at an optimal decision.

Hereinafter, the term “Management and Control System for Organizations”, in accordance with the principles of the present invention, will be referred to by its acronym as MCSO unless it is specifically intended to refer to the term for a “managing and controlling system” (MCS) as is known to those skilled in the art. The term “responsible organization head” may be interpreted as the CEO (Chief Executive Officer), the President, a Vice-President (V.P.), and the like, depending on the title given to the person so delegated and with the authority for top managerial decision-making in a particular organization with reference to setting and maintaining business or organizational performance goals. Unless otherwise specified—and for the sake of simplicity—the designation of a senior (top) managerial authority will be referred to hereinafter as the CEO.

It is another object of the present invention to provide senior managers and their CEO with the ability to easily communicate with one another either individually, or in any combination, utilizing a variety of communication tools (e-mail, SMS, Internet, and the like) operable integrally with the MCSO system of the present invention.

It is yet another object of the present invention to provide a comprehensive software program, in the form of a custom extension application utilizing algorithms which run parallel to the installed Executive Resource Planning (ERP) system and which enable the analysis and presentation of each critical datum preselected to fit a specific organization by providing the relevant organization's data from the ERP database already resident and installed in the organization.

It is a further object of the present invention to provide a system and method that presents in real-time all the critical information required by each senior manager and their CEO—viewable in a single screen distributed within a networked system among top management, enabling a correct and timely response to problems that is both appropriate and effective—culminating in a sought for decision for management of the whole organization and each of its key operating units.

The present invention comprises several innovative items in three areas as follows:
1. Presenting a set of critical data prevalent in the organization while simultaneously dedicating an appropriate perspective to the data combined with an immediate forecast for what is deemed to be anticipated for each datum item.
2. Presenting the existing real-time organizational bottleneck in tandem with using unique organizational indicators.
3. Presenting an aspect of the point of view of the investors in—/share holders of—the organization and the worth of the organization vis-a-vis the stock market, while analyzing the actual Dynamic Return On Investment (D-ROI) which is based on the varying value of the organization in the stock market.

For each entity, such as a department or operating unit, within the organization, the organization selects n critical indicators characterized as Critical Performance Indicators (CPI)] To each such CPI, the management of the organization assigns a specific weight relative to the rest of the indicators for a selectable operating period, such as a month, quarter, year and the like, and provides this value to the MCSO in accordance with the principles of the present invention.

The MCSO retrieves performance data directly from the established and operating ERP system and, as well, by automatic or manual feeding of data from both internal and external data sources.

Applying these data, the algorithms of the system of the present invention execute the calculations pertaining to a cited organizational “bottleneck”, so that the CEO (or equivalent other titled manager) of the company or organization continuously receives an up-to-date organizational “bottleneck” alert via an indicator, shown online as a flashing light in a preferred embodiment of the present invention. Optionally, the organizational “bottleneck” indicator may be an audio alarm, or a combination of both visual and audio alarms as are known to those skilled in the art. This arrangement would enable the CEO to select and assign a scale of his priorities in the organization at any given moment and emphasize the activities in accordance with current developments in the market and within the organization.

Therefore there is provided a system for generating computer displays of data and information via a computer network running as a custom extension application on a platform of an installed Executive Resource Planning system for management and control of an organization, the system comprising:
critical performance indicators of performance states in all operational activities, the indicators arranged by key operating units which together reflect overall organizational performance, being tailored to the hierarchical structure of the organization and displayed in reference to selectable operating periods,
a “red-flag” alert sub-system for notification of critical problems occurring within the organization communicated in real time from the computer displays to the CEO and senior managers for immediate attention,

such that deviations from the critical performance indicators monitored by an algorithm of the management and control system of the organization activate an organizational bottleneck alert communicated directly to the CEO in real time for immediate attention, and

such that the computer displays of data and information are regularly observed and monitored by the CEO and each senior manager within the key operating units to initiate a managerial response to the “red-flag” alert sub-system to improve, in real-time, control and management of operations and decision-making within the organization.

There is also provided a method for generating computer displays of data and information via a computer network running as a custom extension application on a platform of an installed Executive Resource Planning (ERP) system for management and control of an organization, the method comprising:
providing critical performance indicators of performance states in all operational activities, the indicators arranged by key operating units which together reflect overall organizational performance, being tailored to the hierarchical structure of the organization and displayed in reference to selectable operating periods, and
providing a “red-flag” alert sub-system for notification of critical problems occurring within the organization communicated in real time from the computer displays to the CEO and senior managers for immediate attention,

such that deviations from the critical performance indicators monitored by an algorithm of the management and control system of the organization activate an organizational bottleneck alert communicated directly to the CEO in real time for immediate attention, and such that the computer displays of data and information are regularly observed and monitored by the CEO and each senior manager within the key operating units to initiate a managerial response to the “red-flag” alert sub-system to improve, in real-time, control and management of operations and decision-making within the organization.

Further features and advantages of the present invention will become apparent from the drawings and description contained herein.

### BRIEF DESCRIPTION OF THE DRAWINGS

For a better understanding of the invention with regard to the embodiments thereof, reference is made to the accompanying drawings, in which like numerals designate corresponding elements or sections throughout and in which:

FIG. 1 shows a general block diagram of the Management and Control System for Organizations (MCSO) as a custom extension application running on a platform of an installed Executive Resource Planning (ERP) system in accordance with a preferred embodiment of the present invention;

FIG. 2 is a view of the system architecture for the networked computer display screens within the organization operating in conjunction with the MCSO in accordance with the principles of the present invention;

FIG. 3 shows a detailed block diagram of the internal structure of the MCSO in relation to key operating units of a typical organization in accordance with a preferred embodiment of the present invention;

FIG. 4 shows a schematic view of a typical performance diagram presenting a resultant datum obtained from the MCSO of the present invention in accordance with principles thereof, such as displayed for senior managers and the CEO of an organization online; and

FIG. 5 illustrates a schematic view of the numerical presentation of data (values) for each and every activity area within predetermined financial domains.

### DETAILED DESCRIPTION OF THE PREFERRED EMBODIMENTS

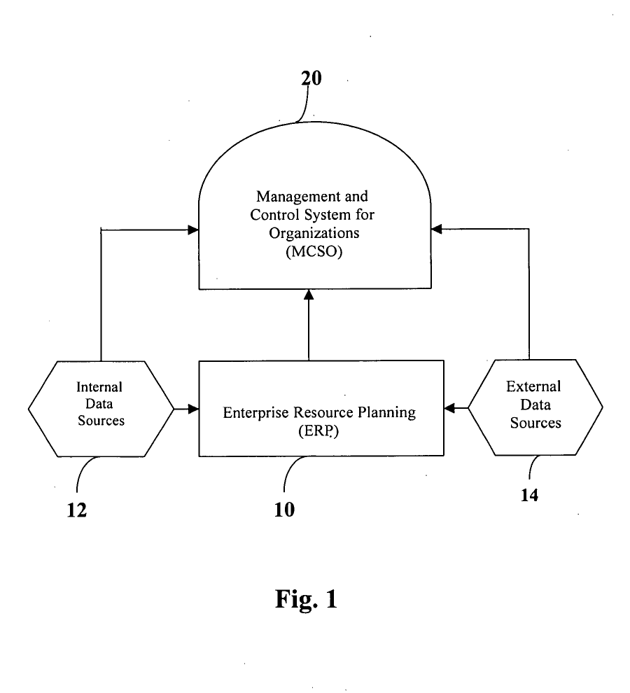

FIG. 1 shows a general block diagram of the Management and Control System for Organizations (MCSO) as a custom extension application running on a platform of an installed Executive Resource Planning (ERP) system in accordance with a preferred embodiment of the present invention. Specifically, FIG. 1 depicts the inter-relationships of the MCSO 20 with the assemblage of all the data existing in the organization. MCSO 20 is fed data from the managerial database of an organization that includes the installed ERP system 10. ERP system 10 is the main and comprehensive system operating within the organization. In addition, MCSO 20 is also simultaneously fed by an internal data and information source 12 and an external data and information source 14.

The task of the MCSO 20 is to provide to the relevant senior responsible managers in the organization an exact and up-to-date picture of the state of organizational activities, including but not limited to budgeting and other performance factors within the organization, so as to enable them to analyze the situation regarding the state of these factors, and also to relate developments to the stock market in general as well as to the investors and share holders, key players in the economic well-being of the organization.

The MCSO 20, receives from the ERP system 10, all the operational data in the organization as it refers and applies to the periodic (monthly, quarterly and annual) designed programs, as expressed in the organization's budgetary plan.

In addition, MCSO 20 computes and presents the forecasted performance of the organization, presenting as before, a periodic picture (display). For this end, it is fed from additional information sources, as follows:
Internal data/information sources 12—providing information fed to the system that includes conformance with the designated CPI (Critical Performance Indicators) data in each and every sub-unit of the organization.
External data/information sources 14 that feeds data extracted from sources outside the organization structure, such as banks, the stock market, via the internet WEB and similar entities.

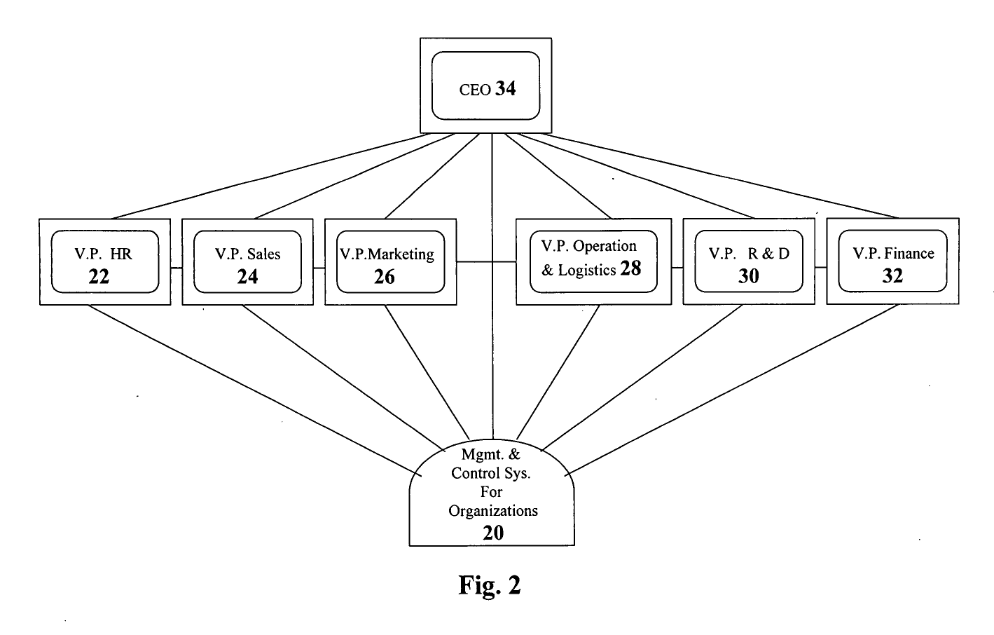

FIG. 2 is a view of the system architecture for the networked computer display screens within the organization operating in conjunction with the MCSO in accordance with the principles of the present invention. FIG. 2 shows the interrelationship within the network among the CEO's online display screen 34 and all other online display screens 22-32 operating in conjunction with the MCSO 20 in accordance with the principles of the present invention. The CEO 34 of the organization is preferably connected to the screens of each and every one of his deputy managers, V.P.s 22-32, and of course is able to view any of these screen displays on the CEO's screen 34.

The organizational entities, such as wings, units, divisions, departments and the like, in a typical business organization, by way of example, are preferably also inter-connected one to the other as shown in FIG. 2 by horizontal lines connecting each of the various V.P. screens 22-32. This embodiment enables the CEO to observe any screen of each V.P. at will, preferably with another option that enables any V.P. to scan any other screen of the system, when required.

It is important to note that the assignments of positions as expressed in FIG. 2 only serves to illustrate examples of common, business organizational entities, such as V.P. for Human Resources (HR) 22, V.P. Sales 24, V.P. Marketing 26, V.P. Operation & Logistics 28, V.P. R&D 30 and V.P. Finance 32.

Obviously, each organization has its own hierarchical structure and assignments of managerial duties (seniors and otherwise) as they find appropriate to suit their structure, business policy and requirements, and even this might vary occasionally. The provision of display screens and authority for access thereto are tailored to suit the hierarchical structure of each user organization individually in order to enable every organization CEO and senior managers within the organization to observe the existing state of performance data, both organization-wide and by selectable operating units and time periods. In a preferred embodiment of the present invention, for every time period there exists a separate activation button on-screen (not shown) that triggers relevant algorithms which are suited to the selectable time period. The CEO and each senior manager can, at their discretion, vary—at any given instant—the time period in which each one is interested.

This data is critical to real-time operations and decision-making. Each datum is displayed simultaneously through the use of indicators on screens of the computer network. The MCSO 20 of the present invention adapts itself to any organizational structure and upgrading step. Hence, FIG. 2 does not limit nor inhibit the present invention to a specific organizational structure. The structure and application limits are only in accordance with the claims.

The MCSO 20 transfers to all the deputy managers, such as V.P.s 22-32, the performance data of the departments that are subject to their jurisdiction, as it applies to the budget, and displays the forecasted data in optionally selectable periodic terms, such as by month, quarter or year.

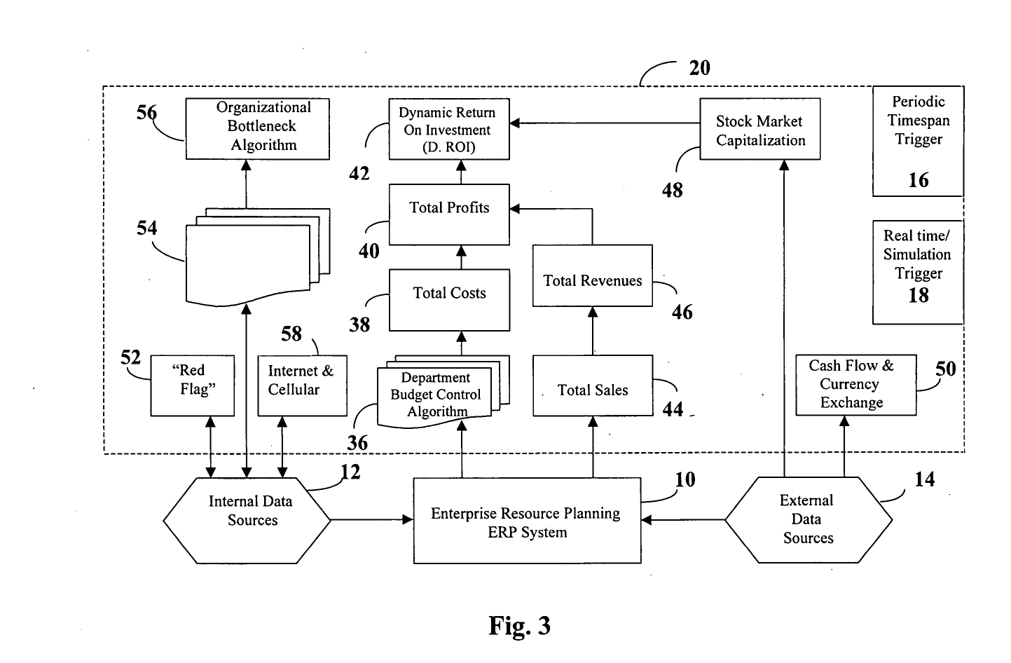

FIG. 3 describes the internal structure of the MCSO 20 and the interaction between the ERP 10 scheme or software and the MCSO 20 and also with the internal data/information sources 12 and the external data/information sources 14.

When a malfunction or failure occurs, one such that it influences the work in progress and prevents conformation with the tasks and the scheduled targets of the organization, any manager that is presented in the MCSO 20 structure (and thus has his specific dedicated screen commensurate with his position and obligations) is able to declare a “Red Flag” 52 through the internal data/information sources 12.

When one of the managers arrives at the conclusion that a “Red Flag” 52 has to be declared, he preferably clicks a legend “Red Flag” on his respective screen (not shown), and using an opened window (“write-in” in the display area), the details the relevant details of the occurrence and transmits it using appropriate integrated communication tools facilitated by MCSO 20. The “Red Flag” 52 announcement is sent, as the, via the internal data/information sources 12 directly to the MCSO 20 and from there—it is sent simultaneously to all the managers that are tied to the MCSO 20, at the actual time of the occurrence. Thus, at the same instant, all managers are provided on their respective screens 22-32 (see FIG. 2) with a view of a blinking “Red Flag” 52 and by pressing the blinking “Red Flag” 52, they are each enabled to read more specific and detailed information and be fully informed of the occurrence.

Internet and cellular communication at block 58 enables communication between management computers and enables sending and receiving SMS messages, e-mail, VoIP, intranet, video pictures for video conferences and also allows the use of a cellular telephone service or the addition of a remote computer to the MCSO 20 in accordance with the principles of the present invention.

The system of the present invention further comprises a telecommunication means sub-system to enable instant communication and transfer of data to the MCSO and to report deviant occurrences in the critical performance indicators to the organization's top management, such as the CEO and V.P., or other senior managers of entities (departments or units) within the organization.

In practice, n Critical Performance Indicators (CPI) at block 54 are assigned to each organizational entity (e.g., a department). They are fed from the above-mentioned internal data/information sources 12 and indicate to what degree the relevant department manager's performance conforms to the planned assignments and tasks.

The critical performance indicators (CPI) 54 are preferably assigned by the top management for all the organization's departments and receive a scale of weighted (graded) influence levels. The MCSO 20 continuously collects all the data required for the CPI calculations and then performs the required calculations by using an Organization Bottleneck algorithm at block 56 aimed at pinpointing the department whose activity constitutes the major and dominant bottleneck in the organization's proceedings, and hence causes delays or serious deviations in performance. In this manner, the CEO is enabled to discern where the core of the problem in the organization is located. In this way, he is then in a position to focus his priorities on the problem entity in order to increase the efficiency and enhance the performance of the organization.

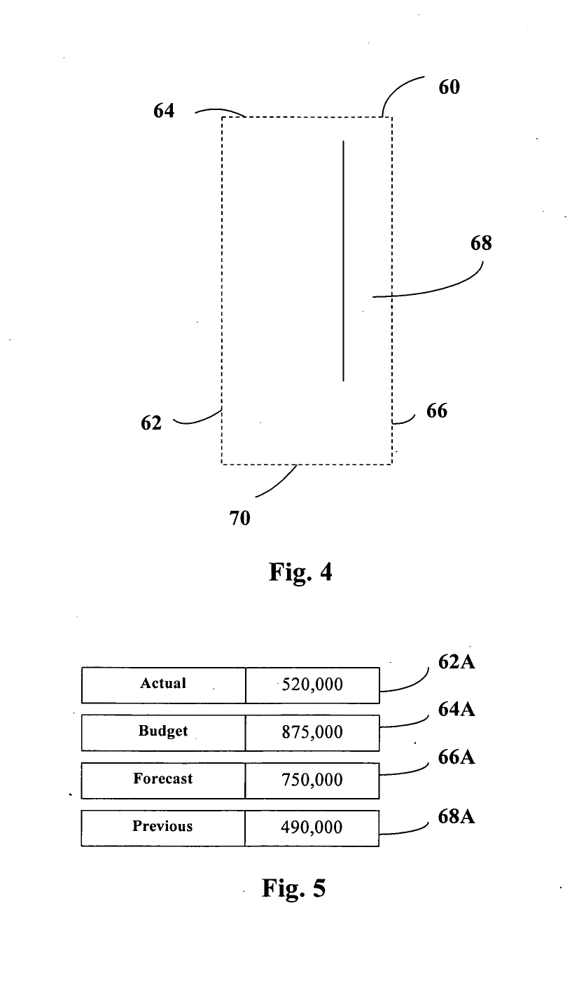

The display of each major department in the organization, namely in respect to screens 22-32 (see FIG. 2) is equipped with a “bottleneck” indicator 70 (see FIG. 4) (in a preferred embodiment of the present invention, indicated by a blinking circular icon on the CEO's screen) that is automatically triggered when a bottleneck occurs in a particular department. Bottleneck Algorithm 56 triggers the blinking of an indicator light 70 (see FIG. 4) for the specific department where a bottleneck occurred for the immediate attention of the CEO.

This holds true all the time, so when another bottleneck is detected; it can be handled at once, immediately and smoothly, by the CEO. Note that preferably the CEO is aware of this in real-time—contributing to enhancing the performance of the organization.

The present invention provides for delving deeper (“drilling down”), for example, into the sales, revenues, costs, cash flow, and profits data of any selected unit of an organization, particularly to improve economic indicators or to analyze and remedy specific problems.

For managing current budgetary control, the ERP system 10 transfers information to each screen 22-32 of the senior managers (as shown in FIG. 2).

By employing Department Budget Control Algorithm 36, a calculation is carried out for each of the departments referenced by screens 22-32 and the results are presented to the CEO both for the actual situation as compared to the budget, and concurrently also in comparison to the updated forecasts resulting from the actual activities. This information, in a preferred embodiment of the present invention, is displayed periodically in optionally selectable operating periods, such as monthly, quarterly and annually. A periodic time-span trigger 16 is provided to toggle between any of these time frames for viewing the displayed data to suit the needs of management personnel.

In addition, a real-time/simulation trigger 18 is provided by the system of the present invention to enable any user to vary any desired datum item of the current operational activity in order to observe its future influence on all levels of organizational activities, including finding a calculated break-even point in terms of sales at any given instant. Real-time/simulation trigger 18 enables optional selection between preferably two modes: real time mode for current information, and simulation mode for theoretical information based on an extension of present performance or hypothetical, simulated situations.

Simultaneously, every senior manager of a department continuously receives the relevant actual performance data for his department, resulting from executed actual activities. This information is also available for display within selectable operating periods as described above. Preferably, each senior manager is enabled to view the display on screens of other departments and scan the data that gives the particular senior manager information on his performance and activities as much as it relates and influences his own department's operation.

A summary of all the expenditures would be expressed in the Total Costs block 38 and this information is optionally presented in one of the three modes as described hereinbefore: (1) actual, (2) compared to the budget, and (3) in comparison to an updated total costs forecasts.

Based on the reports of a sales department, for example, which are fed to the platform ERP system 10, sales data are collected and displayed in the format of diagrams depicting Total Sales at block 44 which are optionally presented in one of three modes: (1) Actual, (2) Compared to the Budget, and also (3) Compared to a Forecast of an updated total sales. More particularly, the computer displays viewed on MCSO graphic screens, in a preferred embodiment of the present invention, provide sales data for the organization within selectable operating periods and simultaneously display this sales data in terms of: actual sales; anticipated sales as per sales budget; updated sales forecast based on actual sales execution; as well as previous sales results for the corresponding time frame of the previous year.

Treating Total Revenues block 46 and Total Costs block 38 results in obtaining the Total Profits block 40. In particular, the computer displays provide for displaying total revenues of the organization within the (optionally) selectable operating periods and simultaneously with data of actual revenues, budgetary revenues, updated forecasted revenues based on actual execution data, and previous revenues results for the corresponding time frame of the previous year.

The computer displays provide total costs of the organization within the selectable operating periods and simultaneously in terms of: actual costs data, budgeted costs, updated forecasted costs based on actual execution data, and previous costs data for the corresponding time frame of the previous year.

The computer displays enable displaying profits of the organization within the selectable operating periods and simultaneously in terms of actual profits, budgeted profits, up-to-date forecasted profits based on actual execution results data, and previous profits results for the corresponding time frame of the previous year.

The Dynamic Return On Investment (D. ROI) block 42 is continuously updated and represents the value of the company's Stock Market Capitalization block 48 (as it is stated in the stock market in accordance with the variations of the shares' value) divided by its current accumulated earnings over a twelve month period, but in the present context, a display would reflect the real-time value. The result, in yearly terms, indicates how long it will take to obtain a return of the investment within the company (business organization), based on the current twelve months' earnings.

The D.ROI block 42 is presented using an algorithm that sums and integrates the accumulated Total Profits block 40 of the past twelve months. From these data, a continuous (current) calculation of the D.ROI block 42 is performed, so that it is provided, in a preferred embodiment of the present invention, on a dedicated display window in the CEO's screen 34 (see FIG. 2), a fluent indication regarding the economic efficiency of the organization.

The computer displays provide for displaying dynamic-return-on-investment (D.ROI) in an organization in terms of current accumulative earnings over the current twelve month period utilizing “current return on investment” as a function of the stock market capitalization value of the outstanding shares of the organization. This indicator serves as measure to the CEO of achieved efficiency of the company's investments at any actual instant.

The results of the data/information from Cash Flow & Currency Exchange block 50 are also displayed on the CEO's screen 34 (see FIG. 2) after adjusting the currency rate to the preferred currency of the organization, as continuously updated by the relevant banks. The calculation is based on the cash flow data and the currency rates received from the relevant banks and provide a continuous picture of the organization's cash flow state, also answering the CEO's needs.

The computer displays serve to display the cash flow of the organization within the same selected operating periods as hereinbefore described and simultaneously in terms of actual cash flow data, budgeted cash flow, up-to-date forecasted cash flow based on actual execution results data, and previous cash flow results within the corresponding time frame of the previous year.

The cash flow is enumerated in terms of currency used by the organization including international currencies which are converted directly into the preferred currency of the organization using exchange rates as determined by a relevant bank serving the organization.

The present invention provides for delving deeper (“drilling down”), for example, into the sales, revenues, costs, cash flow, and profits data of any selected unit of an organization, particularly to improve economic indicators or to analyze and remedy specific problems (such as manpower shortages) which may not be directly to financial matters.

FIG. 4 shows a schematic view of a typical performance diagram presenting a resultant datum obtained from the MCSO of the present invention in accordance with principles thereof, such as displayed for senior managers and the CEO of an organization online. A Performance Presentation Diagram 60, in a preferred embodiment of the present invention, is used to present data and numerical (values) for each and every activity area of an organization. Preferably, these areas are color-coded in online screens for easy viewing. The values (preferably in units of thousands of $) of the relevant data items (of each operation and activity in the organization, such as operational cost, sales, revenues, and other information as described in reference to FIG. 3, are displayed in columns viewable on the screens 22-32 and 34 of top management and the CEO, respectively (see FIG. 2).

This presentation is based on presenting a relative view of the performance for each department in the organization and its meanings for a selectable period (month, quarter, or year). Each presentation for each department includes multi-dimensional data, as each datum is shown by preferably four columns (dimensions), showing respectively: (a) the actual performance results (Actual) block 62, (b) the planned budgetary allocations (Budget) block 64, (c) the forecasted performance (Forecast) block 66 and (d) the previous performance of each datum, as was performed within the respective last period (Previous) block 68. Alternatively, other values and periods may be selected for presentation in addition to or in place of the ones given by way of example in FIG. 4

All the performance data are presented in accordance with the period selected by the CEO for viewing each department performance on the CEO's screen 34 (see FIG. 2). Moreover, each V.P. is enabled similarly, to view the performance of each activity within his department (and possibly other departments) in accordance with his selected period of activity. In a preferred embodiment of the present invention, for every operating period (e.g., monthly, quarterly, or annually) a virtual pushbutton can be activated online in the computer displays to trigger the relevant algorithm that is suited to the selected operating period. A senior manager has the discretion to vary, at any given moment, the time frame in which to observe the data/information of choice.

By observing the actual result versus the budgeted requirement as related to the updated forecast and the previous result for this cited performance element, the CEO, as well as his V.P.'s, can respond immediately by making a relevant decision and implementing an action item.

FIG. 4 shows a schematic view of a typical performance diagram presenting a resultant datum obtained from the MCSO of the present invention in accordance with principles thereof, such as displayed for senior managers and the CEO of an organization online. The performance diagram of the organization gives comprehensive information relating to each and every major relevant parameter in the organization, such as operational cost, sales, revenues, budget of the departments and the like. These diagrams that are specifically related to each department, appear on the relevant department's screen 22-32 (from FIG. 2) as well as on the CEO's screen 34 and may also be scanned by any other of the senior management.

Any V.P. of the organization can observe on his screen not only the data pertaining to the performance of his department, but also the data that provides information pertaining to his activity area (in any other relevant department activity).

At the bottom of each visual Performance Presentation Diagram 60 there preferably is provided an indicator light 70. It is lit (turned ON) when a specific department's activity within the organization turns out to be an organizational bottleneck in the operation, causing delays in the organization's functioning. Organizational bottleneck block 52 is automatically activated as per the CPI (Critical Performance Indicators) 54 as shown in FIG. 3.

FIG. 5 illustrates a schematic view of the numerical presentation of data (values) for each and every activity area within predetermined financial domains. Numerical values are displayed in thousands of $ for each and every activity area shown in FIG. 4 in accordance with the columnar blocks 62, 64, 66, and 68. Block 62A represents the numerical value of column 62. Block 64A represents the numerical value of column 64. Block 66A represents the numerical value of column 66, while block 68A represents the numerical value of column 68. The numerical display is provided for immediate executive summary of the data/information displayed in Performance Presentation Diagram 60 of FIG. 4 and the values shown are intended only for illustrative purposes.

Having described the present invention with regard to certain specific embodiments thereof, it is to be understood that the description and accompanying drawings are set forth merely for purposes of example and that many other variations, modifications, and applications of the present invention may be made and therefore should not be construed as a limitation, since further modifications may now become apparent to those skilled in the art, and it is intended to cover such modifications as fall within the scope of the appended claims.

I claim:

1. A system for generating computer displays of data and information via a computer network running as a custom extension application on a platform of an installed Executive Resource Planning system for management and control of an organization, said system comprising:
critical performance indicators of performance states in all operational activities, said indicators arranged by key operating units which together reflect overall organizational performance, being tailored to the hierarchical structure of said organization and displayed in reference to selectable operating periods,
a “red-flag” alert sub-system for notification of critical problems occurring within said organization communicated in real time from said computer displays to the CEO and senior managers for immediate attention,
such that deviations from said critical performance indicators monitored by said custom extension application of said management and control system of the organization activate an organizational bottleneck alert communicated directly to the CEO in real time for immediate attention, and
such that said computer displays of data and information are regularly observed and monitored by the CEO and each senior manager within said key operating units to initiate a managerial response to said “red-flag” alert sub-system to improve, in real-time, control and management of operations and decision-making within said organization.

2. The system of claim 1, further comprising:
a real-time/simulation trigger linked to said computer displays for selective toggling between a real-time and a simulation mode for viewing said data and information;
a periodic time-span trigger linked to said computer displays for viewing said data and information within the time frames of selectable operating periods of activity of said organization; and
a telecommunication means to enable instant communication and transfer of data and information to said system comprising: Internet and cellular communication systems operable integrally with said management and control system for organizations enabling easy communication either individually, or in any combination, between the CEO and senior managers within said organization, including: sending and receiving SMS messages, e-mail, VoIP, intranet, video pictures for video conferences, use of a cellular telephone service, and the addition of a remote computer to said system.

3. The system of claim 1, wherein said ERP platform provides relevant organization data and information from the ERP database already resident in said organization to said custom extension application.

4. The system of claim 1, wherein the critical performance indicators comprise for each entity within said organization selected n critical indicators characterized as Critical Performance Indicators having assigned to each a specific weight relative to the rest of said indicators for a selectable operating period.

5. The system of claim 1, wherein said CEO and senior managers are enabled to analyze said selected critical performance indicators which bear on financial aspects of said organization in comparison to a reference stock market, interests of investors, and cash flow within said organization.

6. The system of claim 1, wherein said performance states comprise at least one of:
actual performance state;
preplanned budget state;
a forecast state based on projections of current performance; and
a previous performance state within a selectable operating period.

7. The system of claim 6, wherein said performance states reflect results data comprising:
actual results—analyzed as per data drawn from a data collecting system of said installed ERP used by said organization and that presents a sum of actual results for each activity area of said organization and of said organization as a whole, in each given moment and within said selectable operating periods;
required results—as per budgetary data, fed from said organizational budget data for each activity area separately and of said organization as a whole, within said selectable operating periods;
results forecast for each separate activity area and for said organization as a whole, based on analyzing said actual results and calculating said results forecast to compare with said required results budgetary data within said selectable operating periods; and
previous results from the corresponding time frame of the previous year, within said selectable operating periods.

8. The system of claim 1, wherein said key operating units comprise at least organizational entities selected from the group: Human Resources, Sales, Marketing, Operation & Logistics, R&D, and Finance.

9. The system of claim 1, wherein said selectable operating period comprises a measurable, recurring time cycle of activity selected from among one of least: monthly, quarterly and annual time periods.

10. The system of claim 1, wherein said “red-flag” alert sub-system enables each senior manager to generate an alert warning in real time, communicated to said network as a result of critical problems arising in a specific area within said organization.

11. The system of claim 1, wherein said organizational bottleneck is signaled by an indicator light provided within a display screen associated with each of said key operating units, said indicator light being lit in the CEO's screen display to indicate a critical performance indicator problem requiring the immediate attention of the CEO.

12. The system of claim 1, wherein said real-time/simulation trigger enables any user to vary any desired datum item of the current operational activity in order to observe on said computer displays results of both present and future influences on all levels of organizational activities, including finding a calculated break-even point in terms of sales at any given instant and to generate hypothetical outcomes from sensitivity analysis of various “What if” questions within said organization.

13. The system of claim 1, wherein said computer displays provide a CEO of said organization to optionally select and view at a single glance a simultaneous graphic display of said key operating units arranged side-by-side in performance diagrams of data from each and viewable in any of said selectable operating periods to facilitate comparison and effective decision-making and to provide an immediate perspective for each specific datum item.

14. The system of claim 1, wherein said computer displays enable the CEO and senior managers to observe and delve deeply into selected details of any area: within selected key operating units from all activity areas of said organization; within said selectable operating periods; and within any combination of the aforesaid, said selected details comprising at least one datum item selected from: sales, revenues, costs, cash flow, and profits for any selected said key operating unit.

15. The system of claim 1, wherein said computer displays enable any said senior manager of said organization to apply control measures to his activity areas in a detailed manner in response to the status of the performance level of activities within his domain of operation; said status being displayed in real-time results relating to the specific budget of said senior manager, as well as indicating expected results to be gained by said control measures.

16. The system of claim 1, wherein said computer displays provide sales data for said organization within said selectable operating periods and simultaneously display said sales data in terms of: actual sales; anticipated sales as per sales budget; updated sales forecast based on actual sales execution; and previous sales results for the corresponding time frame of the previous year.

17. The system of claim 1, wherein said computer displays provide for displaying total revenues of said organization within said selectable operating periods and simultaneously with data of actual revenues, budgetary revenues, updated forecasted revenues based on actual execution data, and previous revenues results for the corresponding time frame of the previous year.

18. The system of claim 1, wherein said computer displays provide total costs of said organization within said selectable operating periods and simultaneously in terms of: actual costs data, budgeted costs, updated forecasted costs based on actual execution data, and previous costs data for the corresponding time frame of the previous year.

19. The system of claim 1, wherein said computer displays enable displaying profits of said organization within said selectable operating periods and simultaneously in terms of actual profits, budgeted profits, up-to-date forecasted profits based on actual execution results data, and previous profits results for the corresponding time frame of the previous year.

20. The system as in claim 1, wherein said computer displays provide for displaying dynamic-return-on-investment in said organization in terms of current accumulative earnings over the current twelve month period utilizing “current return on investment” as a function of the stock market capitalization value of the outstanding shares of said organization.

21. The system in accordance with claim 1, wherein said computer displays serve to display cash flow of said organization within said selected operating periods and simultaneously in terms of actual cash flow data, budgeted cash flow, up-to-date forecasted cash flow based on actual execution results data, and previous cash flow results within the corresponding time frame of the previous year.

22. The system of claim 21, wherein said cash flow is enumerated in terms of currency used by said organization including international currencies which are displayed in the preferred currency of said organization using exchange rates determined by a relevant bank serving said organization.

23. A method for generating computer displays of data and information via a computer network running as a custom extension application on a platform of an installed Executive Resource Planning system for management and control of an organization, said method comprising:
providing critical performance indicators of performance states in all operational activities, said indicators arranged by key operating units which together reflect overall organizational performance, being tailored to the hierarchical structure of said organization and displayed in reference to selectable operating periods, and
providing a “red-flag” alert sub-system for notification of critical problems occurring within said organization communicated in real time from said computer displays to the CEO and senior managers for immediate attention,
such that deviations from said critical performance indicators monitored by said custom extension application of said management and control system of the organization activate an organizational bottleneck alert communicated directly to the CEO in real time for immediate attention, and
such that said computer displays of data and information are regularly observed and monitored by the CEO and each senior manager within said key operating units to initiate a managerial response to said “red-flag” alert sub-system to improve, in real-time, control and management of operations and decision-making within said organization.
